(19) United States
(12) Patent Application Publication
(10) Pub. No.: US 2011/0300337 A1
(43) Pub. Date: Dec. 8, 2011

(54) SUBSTRATE FOR LIGHT-EMITTING DIODE

(76) Inventor: Chuan-Cheng TU, Taipei City (TW)

(21) Appl. No.: 13/091,747

(22) Filed: Apr. 21, 2011

(30) Foreign Application Priority Data
Jun. 8, 2010 (TW) 099118631

(51) Int. Cl. B32B 3/00

(52) U.S. Cl. 428/156; 428/141

(57) ABSTRACT

A substrate for light-emitting diode (LED) has a top surface being divided into a plurality of first units and a plurality of second units. The first units respectively have a plurality of first microstructures, and the second units respectively have a plurality of second microstructures different from the first microstructures of the first units. Any two adjacent ones of the first units have one second unit located therebetween, while the second units are located around each of the first units. The second units are micro-roughened surfaces that have a relatively small average height difference between tops and bottoms thereof, allowing bridging structures formed on the second units to have bottom portions with uniform thickness, which in turn enables increased good yield of LED production.

### FIELD OF THE INVENTION

The present invention relates to a substrate for light-emitting diode (LED), and more particularly to an LED substrate that enables bridging structures formed thereon to have bottom portions with uniform thickness to thereby enable increased good yield of LED production.

### BACKGROUND OF THE INVENTION

Light-emitting diode (LED) is a light emitting element using semiconductor as a material thereof. According to the light emitting principle of LED, photons are emitted during recombination of carriers in the semiconductor. The LED is also referred to as the fourth generation of lighting source or green lighting source, and is now the top star product catching the public's attention.

Generally, an LED chip is formed by providing a plurality of semiconductor layers on a substrate for LED, which will also be briefly referred to as “LED substrate” herein. The LED substrate may be made of sapphire, silicon (Si), silicon carbide (SiC), germanium (Ge), or gallium arsenide (GaAs). To effectively upgrade the external quantum efficiency (EQE) of the LED chip, many improving methods have been proposed. Among others, the method providing significant improvement includes the step of roughening the surface of the LED substrate or forming protruding or recess microstructures on the surface of the LED substrate. By doing this, the optical waveguide effect in the LED chip is interrupted to thereby increase the external quantum efficiency thereof.

FIG. 1 is a conceptual view of a conventional LED substrate with a semiconductor layer 5 and bridging structures 3 formed thereon. As shown in FIG. 1 from bottom to top, the LED substrate 1 is located at a lowest position, the semiconductor layer 5 is provided atop the substrate, and the bridging structures 3 are provided atop the semiconductor layer 5. However, during the process of forming the bridging structures on the semiconductor layer, the protruding or recess microstructures 4 formed on the LED substrate tend to result in unevenness at bottom portions 31 of the bridging structures 3. That is, the bridging structures 3 will have bottom portions 31 with non-uniform thickness. When the thickness of the bottom portions 31 is too small, such as the case indicated by the double arrow in FIG. 1, the bottom portions 31 of the bridging structures 3 are easily subjected to breaking to thereby cause lowered good yield of LED production. Thus, the prior art LED substrate still requires improvement.

To overcome the drawbacks in the prior art LED substrate, the inventor has developed an improved LED substrate.

### SUMMARY OF THE INVENTION

A primary object of the present invention is to provide a substrate for LED that allows bridging structures formed thereon to have bottom portions with uniform thickness.

Another object of the present invention is to provide a substrate for LED that enables increased good yield of epitaxy or LED production.

To achieve the above and other objects, the substrate for LED according to the present invention has a top surface being divided into a plurality of first units and a plurality of second units. The first units respectively have a plurality of first microstructures, and the second units respectively have a plurality of second microstructures different from the first microstructures of the first units. The second microstructures may be, for example, micro-roughened surfaces having surface unevenness lower than 20 nm. Any two adjacent ones of the first units have one second unit located therebetween, while the second units are located around each of the first units. Since the second units are micro-roughened surfaces having surface unevenness lower than 20 nm, bridging structures formed on the second units can have bottom portions with uniform thickness, which in turn enables increased good yield of LED production.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of a conventional LED substrate with a semiconductor layer and bridging structures formed thereon;

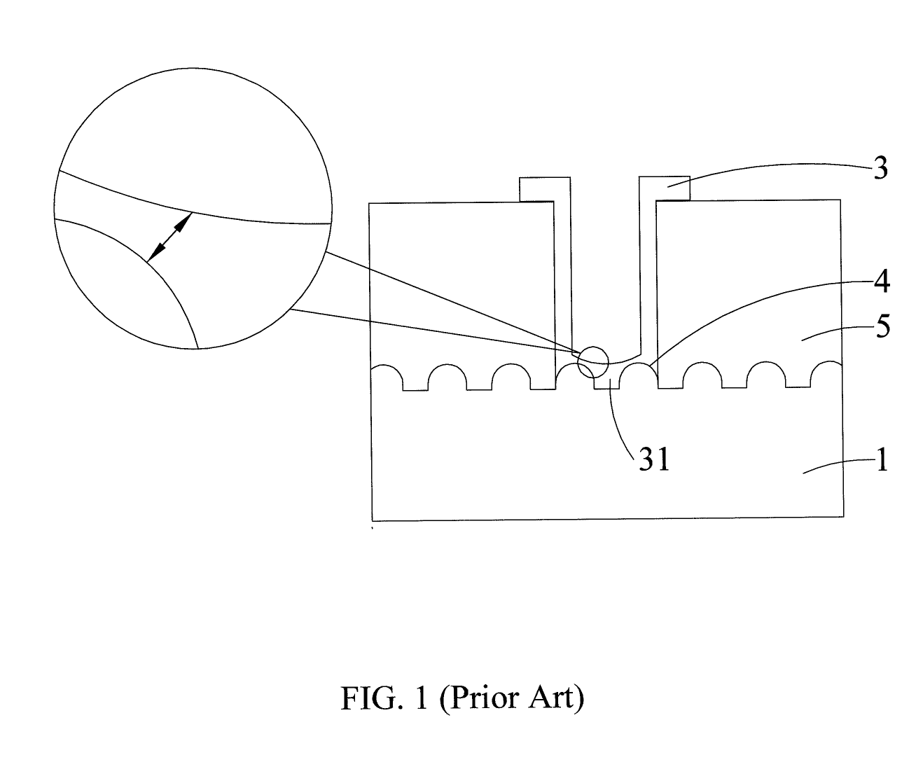

FIG. 2 is a schematic top view of an LED substrate according to a first preferred embodiment of the present invention;

FIG. 3 is a schematic sectional view of the LED substrate according to the first preferred embodiment of the present invention;

FIG. 4 is a schematic sectional view of the LED substrate according to the first preferred embodiment of the present invention with a semiconductor layer and bridging structures formed thereon;

FIG. 5 is a schematic sectional view of the LED substrate according to a second preferred embodiment of the present invention with a semiconductor layer and bridging structures formed thereon;

FIG. 6 is a schematic sectional view of the LED substrate according to a third preferred embodiment of the present invention with a semiconductor layer and bridging structures formed thereon; and

FIG. 7 is a schematic sectional view of the LED substrate according to a fourth preferred embodiment of the present invention with a semiconductor layer and bridging structures formed thereon.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

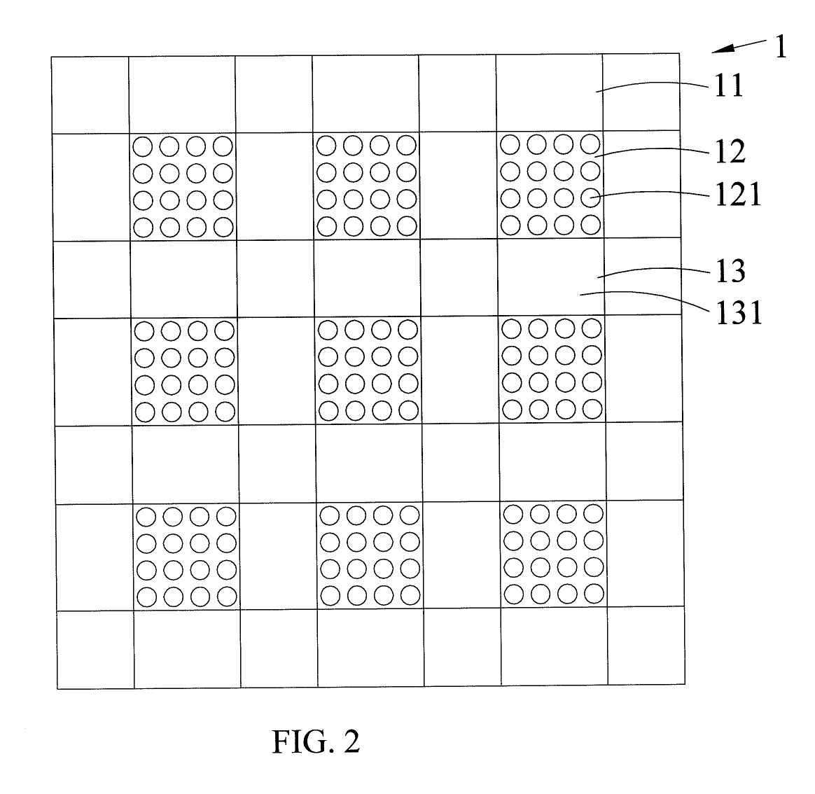

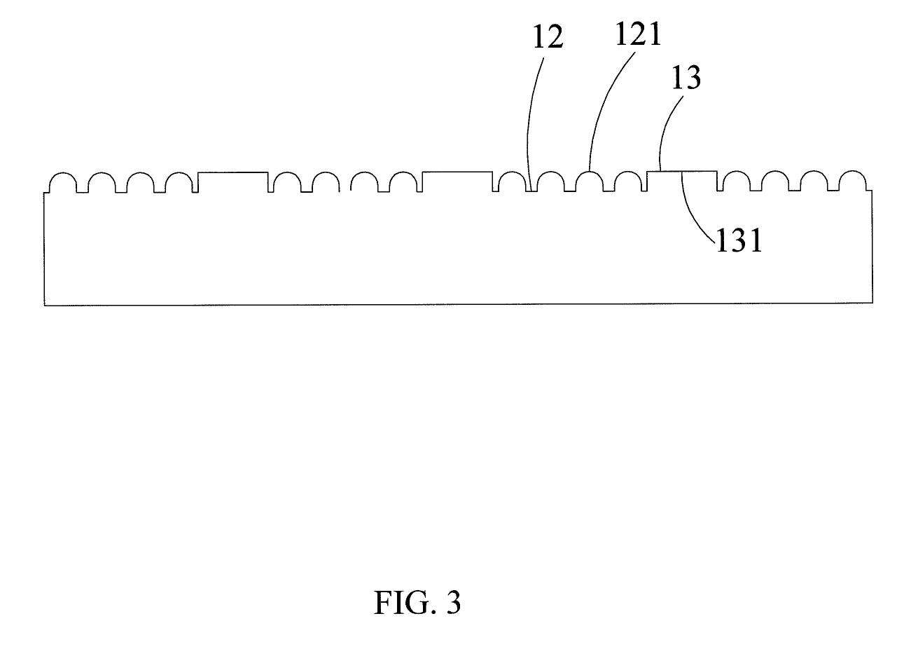

Please refer to FIG. 2 that is a schematic top view of an LED substrate 1 according to a first preferred embodiment of the present invention. As shown, the LED substrate 1 in the first preferred embodiment has a top surface 11 being divided into a plurality of first units 12 and a plurality of second units 13. The top surface 11 can be a crystal growth surface. The first units 12 respectively have a plurality of protruding first microstructures, such as protruding structures 121, which may have a round, a trapezoidal or a conical cross section. An average height difference between tops and bottoms of the protruding structures 121 is above 0.2 μm. The second units 13 respectively have a plurality of second microstructures different from the first microstructures of the first units 12. The second microstructures may be, for example, micro-roughened surfaces 131, which respectively have surface unevenness lower than 20 nm. Please also refer to FIG. 3 that is a schematic sectional view of the LED substrate according to the first preferred embodiment of the present invention. Any two adjacent ones of the first units 12 have one second unit 13 located therebetween, while the second units 13 are located around each of the first units 12. The substrate 1 can be made of a material selected from the group consisting of sapphire, silicon (Si), silicon carbide (SiC), germanium (Ge), and gallium arsenide (GaAs).

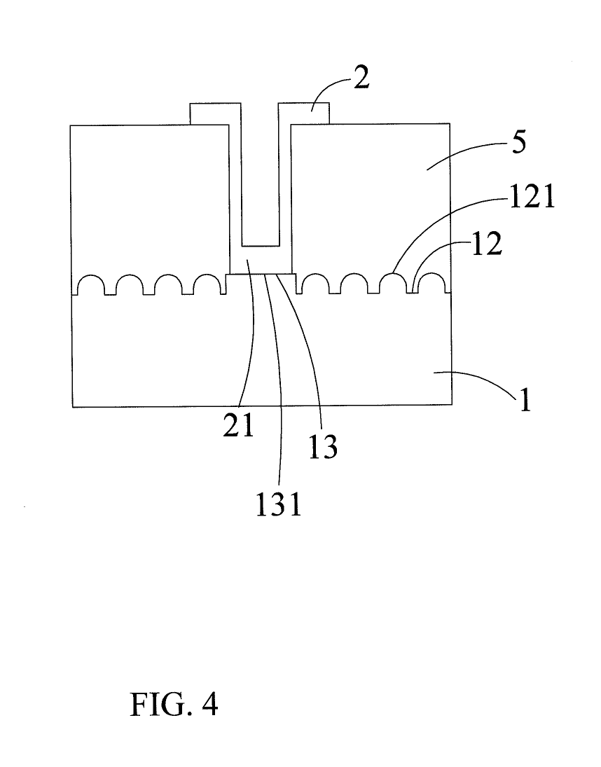

FIG. 4 is a schematic sectional view of the LED substrate 1 according to the first preferred embodiment of the present invention with a semiconductor layer 5 and bridging structures 2 formed thereon. As shown in FIG. 4 from bottom to top, the LED substrate I is located at a lowest position, the semiconductor layer 5 is located atop the substrate 1, and the bridging structures 2 are located atop the semiconductor layer 5. The semiconductor layer 5 is provided with through holes, and the bridging structures 2 are formed in the through holes with respective bottom portion 21 contacting with the second units 13. Since the second units 13 are micro-roughened surfaces 131 respectively having surface unevenness lower than 20 nm, the bottom portions 21 of the bridging structures 2 can respectively have uniform thickness to thereby enable increased good yield of LED production.

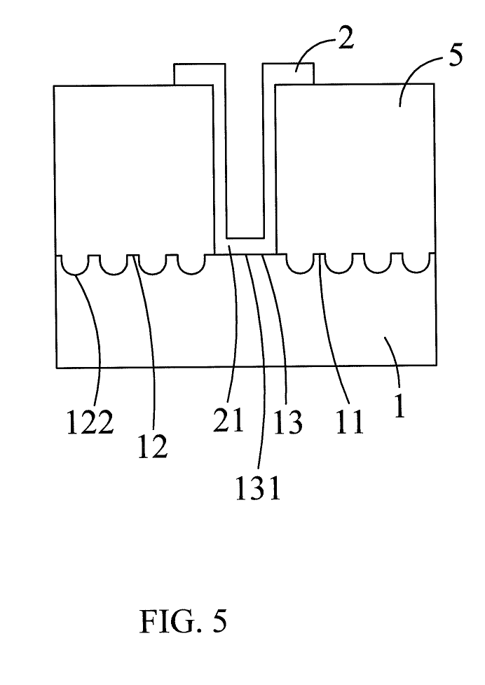

FIG. 5 is a schematic sectional view of the LED substrate 1 according to a second preferred embodiment of the present invention with a semiconductor layer 5 and bridging structures 2 formed thereon. As shown in FIG. 5 from bottom to top, the LED substrate 1 is located at a lowest position, the semiconductor layer 5 is located atop the substrate 1, and the bridging structures 2 are located atop the semiconductor layer 5. Similarly, the substrate 1 in the second preferred embodiment has a top surface 11 being divided into a plurality of first units 12 and a plurality of second units 13. The top surface 11 can be a crystal growth surface. The second embodiment is different from the first embodiment in that the first units 12 thereof respectively have a plurality of recess first microstructures, such as recess structures 122, which may have a round, a trapezoidal or a conical cross section. An average height difference between tops and bottoms of the recess structures 122 is above 0.2 μm. In the second embodiment, the second units 13 also respectively have a plurality of second microstructures different from the first microstructures of the first units 12. The second microstructures may be, for example, micro-roughened surfaces 131, which respectively have surface unevenness lower than 20 nm. Any two adjacent ones of the first units 12 have one second unit 13 located therebetween, while the second units 13 are located around each of the first units 12, similar to that shown in FIG. 2. Similarly, the substrate 1 can be made of a material selected from the group consisting of sapphire, silicon (Si), silicon carbide (SiC), germanium (Ge), and gallium arsenide (GaAs); and the bridging structures 2 are formed with respective bottom portion 21 located within and contacting with the second units 13. Since the second units 13 are micro-roughened surfaces 131 respectively having surface unevenness lower than 20 nm, the bridging structures 2 can respectively have a bottom portion 21 with uniform thickness to thereby enable increased good yield of LED production.

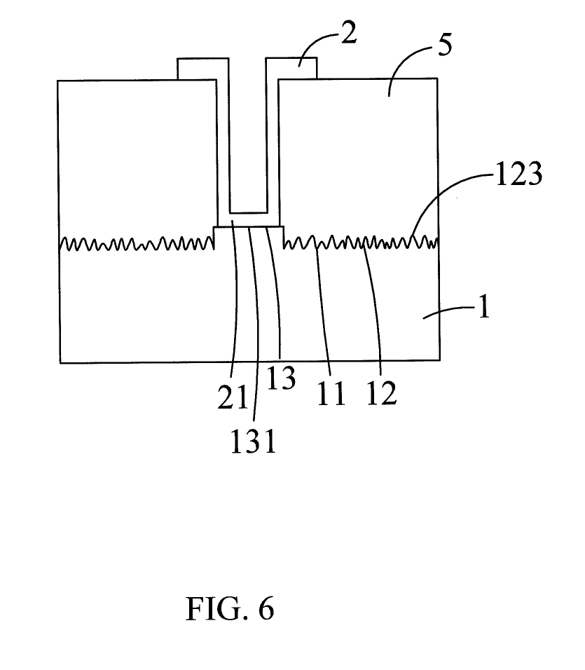

FIG. 6 is a schematic sectional view of the LED substrate 1 according to a third preferred embodiment of the present invention with a semiconductor layer 5 and bridging structures 2 formed thereon. As shown in FIG. 6 from bottom to top, the LED substrate 1 is located at a lowest position, the semiconductor layer 5 is located atop the substrate 1, and the bridging structures 2 are located atop the semiconductor layer 5. Similarly, the substrate 1 in the third preferred embodiment has a top surface 11 being divided into a plurality of first units 12 and a plurality of second units 13. The top surface 11 can be a crystal growth surface. The third embodiment is different from the previous embodiments in that the first units 12 thereof respectively have a roughened surface 123. An average height difference between tops and bottoms of the roughened surfaces 123 is above 0.2 μm. In the third embodiment, the second units 13 also respectively have a plurality of second microstructures different from the roughened surfaces 123 of the first units 12. The second microstructures may be, for example, micro-roughened surfaces 131, which respectively have surface unevenness lower than 20 nm. Any two adjacent ones of the first units 12 have one second unit 13 located therebetween, while the second units 13 are located around each of the first units 12, similar to that shown in FIG. 2. Similarly, the substrate 1 can be made of a material selected from the group consisting of sapphire, silicon (Si), silicon carbide (SiC), germanium (Ge), and gallium arsenide (GaAs). Since the second units 13 are micro-roughened surfaces 131 respectively having surface unevenness lower than 20 nm, the bridging structures 2 can respectively have a bottom portion 21 with uniform thickness to thereby enable increased good yield of LED production.

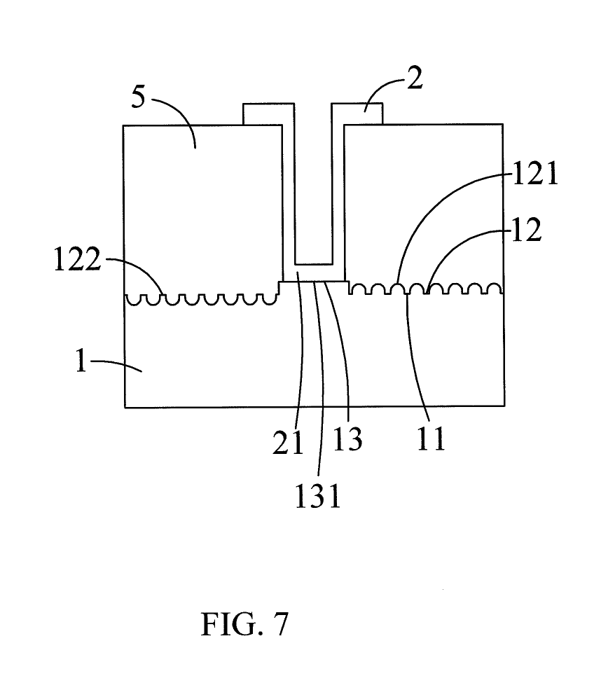

Please refer to FIG. 7 that is a schematic sectional view of the LED substrate 1 according to a fourth preferred embodiment of the present invention with a semiconductor layer 5 and bridging structures 2 formed thereon. As shown in FIG. 7 from bottom to top, the LED substrate 1 is located at a lowest position, the semiconductor layer 5 is located atop the substrate 1, and the bridging structures 2 are located atop the semiconductor layer 5. Similarly, the substrate 1 in the fourth preferred embodiment has a top surface 11 being divided into a plurality of first units 12 and a plurality of second units 13. The top surface 11 can be a crystal growth surface. The fourth embodiment is different from the previous embodiments in that the first units 12 thereof respectively have a plurality of first microstructures, such as a plurality of protruding structures 121 and a plurality of recess structures 122. An average height difference between tops and bottoms of the protruding structures 121 or the recess structures 122 is above 0.2 μm. In the fourth embodiment, the second units 13 also respectively have a plurality of second microstructures different from the protruding structures 121 and the recess structures 122 of the first units 12. The second microstructures may be, for example, micro-roughened surfaces 131, which respectively have surface unevenness lower than 20 nm. Any two adjacent ones of the first units 12 have one second unit 13 located therebetween, while the second units 13 are located around each of the first units 12, similar to that shown in FIG. 2. Similarly, the substrate 1 can be made of a material selected from the group consisting of sapphire, silicon (Si), silicon carbide (SiC), germanium (Ge), and gallium arsenide (GaAs). Since the second units 13 are micro-roughened surfaces 131 respectively having surface unevenness lower than 20 nm, the bridging structures 2 can respectively have a bottom portion 21 with uniform thickness to thereby enable increased good yield of LED production.

It is noted that the LED substrate is generally further provided thereon with other layers, including at least, for example, an N-type semiconductor layer, a light-emitting layer laid on the N-type semiconductor layer, a P-type semiconductor layer laid on the light-emitting layer, and the like. Since the details of these layers are not the main subjects of the present invention, they are generally referred to or represented by the semiconductor layer 5 or are omitted from the description without being discussed in details.

In conclusion, the LED substrate according to the present invention at least provides the advantage of enabling increased good yield of LED production. Since the second units 13 are micro-roughened surfaces 131 with surface unevenness lower than 20 nm, the bridging structures 2 may respectively have a bottom portion 21 with uniform thickness to enable increased good yield of LED production.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A substrate for light-emitting diode (LED), comprising:
a plurality of first units being formed on a top surface of the substrate for LED; and
a plurality of second units being formed on the top surface of the substrate for LED;
wherein the first units respectively have a plurality of first microstructures, and the second units respectively have a plurality of second microstructures different from the first microstructures of the first units; and each of the first units is located between the second units.

2. The substrate for LED as claimed in claim 1, wherein the first microstructures are a plurality of protruding structures having an average height difference above 0.2 μm between tops and bottom thereof.

3. The substrate for LED as claimed in claim 2, wherein the protruding structures respectively have a cross section selected from the group consisting of a round cross section, a trapezoidal cross section, and a conic cross section.

4. The substrate for LED as claimed in claim 1, wherein the first microstructures are a plurality of recess structures having an average height difference above 0.2 μm between tops and bottoms thereof.

5. The substrate for LED as claimed in claim 4, wherein the recess structures respectively have a cross section selected from the group consisting of a round cross section, a trapezoidal cross section, and a conic cross section.

6. The substrate for LED as claimed in claim 1, wherein the second microstructures are micro-roughened surfaces.

7. The substrate for LED as claimed in claim 6, wherein the micro-roughened surfaces respectively have surface unevenness lower than 20 nm.

8. A substrate for light-emitting diode (LED), comprising:
a plurality of first units with roughened surfaces being formed on a top surface of the substrate for LED; and
a plurality of second units being formed on the top surface of the substrate for LED;
wherein the second units respectively have a plurality of second microstructures different from the roughened surfaces of the first units; and any two adjacent ones of the first units have one second unit located therebetween, while the second units are located around each of the first units.

9. The substrate for LED as claimed in claim 8, wherein the roughened surfaces of the first units have an average height difference above 0.2 μm.

10. The substrate for LED as claimed in claim 8, wherein the second microstructures of the second units are micro-roughened surfaces, and the micro-roughened surfaces respectively have surface unevenness lower than 20 nm.
